(19) United States
(12) Patent Application Publication
(10) Pub. No.: US 2015/0122009 A1
(43) Pub. Date: May 7, 2015

(54) SYSTEMS AND METHODS FOR TEMPERATURE COMPENSATED FLOW SENSING

(71) Applicant: Amphenol Thermometrics, Inc., Saint Marys, PA (US)

(72) Inventors: Ertugrul Berkcan, Clifton Park, NY (US); Ibrahim Issoufou Kouada, Niskayuna, NY (US); Michael Klitzke, Nevada City, CA (US); Nannan Chen, Clifton Park, NY (US)

(21) Appl. No.: 14/072,234

(22) Filed: Nov. 5, 2013

(51) Int. Cl. G01F 1/68

(52) U.S. Cl. CPC G01F 1/68
USPC 73/204.11

(57) ABSTRACT

Systems and methods for temperature compensated flow sensing are provided. One system includes a flow disturber disposed in a flow conduit, wherein the flow disturber is configured to impart a flow disturbance to the fluid flow. The system further includes a plurality of flow sensors disposed in the flow conduit, wherein the plurality of sensors are responsive to flow characteristics in the flow conduit. The system also includes at least one temperature sensor disposed in the flow conduit, wherein the at least one temperature sensor is responsive to temperature characteristics in a vicinity of the plurality of flow sensors. The system additionally includes a measurand separator configured to generate an output signal based on at least one of the flow characteristics or temperature characteristics. The system includes a processor configured to determine a temperature compensated flow rate of the fluid flow in the flow conduit using the output signal.

### BACKGROUND

Flow sensing may be used in a variety of different applications, such as to determine flow velocity of a fluid, such as gas (e.g., air) or liquid, through a pipe or tube. For example, flow sensing may be used in ventilation and respiration machines to detect and control the level of air flow. As another example, flow sensing may be used in gas metering systems, such as for residential applications.

The determination of the fluid flow may be affected by many different factors, such as temperature, moisture variations, or the type or density of fluid, among others. Some conventional systems are not satisfactorily responsive these different factors. As a result, the outputs of these systems may drift and cause readings that are not accurate. Additionally, the robustness of these systems suffer.

In a medical setting, when using ventilation and respiration machines such as continuous positive airway pressure (CPAP) machine and a variable positive airway pressure (VPAP) machine, it is important to be able to accurately determine the flow rate of ventilation and/or respiration. For example, the air supply pressure from these machines is varied based on whether the person is breathing in or out, such as during inspiration and expiration phases of the respiratory system. By properly controlling the air flow during different phases of breathing, a more comfortable process results. The more comfortable the ventilation and/or respiratory machine is to a person during use, the more likely the person is to continue to use the ventilation and/or respiratory machine. Users of ventilation and/or respiratory machines may unilaterally decide to cease use of the machine as a result of the machine being uncomfortable during operation, such as when an appropriate air pressure is not supplied, such as during snoring or when the machine is not operating properly. However, due to the complex nature of breathing and the change in direction and speed of air flow during breathing (as well as other factors), it is very difficult to determine flow rates.

### BRIEF DESCRIPTION

In accordance with various embodiments, a flow sensor assembly is provided that includes a flow conduit configured to allow fluid flow therethrough and a flow disturber disposed in the flow conduit, wherein the flow disturber is configured to impart a flow disturbance to the fluid flow. The flow sensor assembly further includes a plurality of flow sensors disposed in the flow conduit to have a geometrical and functional relationship with the flow conduit and the flow disturber, wherein the plurality of sensors are responsive to flow characteristics in the flow conduit. The flow sensor assembly also includes at least one temperature sensor disposed in the flow conduit to have a geometrical and functional relationship with the plurality of flow sensors, wherein the at least one temperature sensor is responsive to temperature characteristics in a vicinity of the plurality of flow sensors. The flow sensor assembly additionally includes a measurand separator coupled to the plurality of flow sensors and the at least one temperature sensor, wherein the measurand separator is configured to generate an output signal based on at least one of the flow characteristics or temperature characteristics. The flow sensor assembly also includes a processor coupled to the plurality of flows sensors, the at least one temperature sensor, and the measurand separator, wherein the processor is configured to determine a temperature compensated flow rate of the fluid flow in the flow conduit using the output signal. The processor is further configured to use the output signal from the measurand separator to select a processing method for determining the temperature compensated flow rate in the flow conduit.

In accordance with other various embodiments, a method for determining flow rate in a conduit is provided that includes positioning within a flow conduit a flow disturber configured to impart a flow disturbance to the fluid flow and disposing a plurality of flow sensors in the flow conduit to have a geometrical and functional relationship with the flow conduit and the flow disturber, wherein the plurality of sensors are responsive to flow characteristics in the flow conduit. The method also includes disposing at least one temperature sensor in the flow conduit to have a geometrical and functional relationship with the plurality of flow sensors, wherein the at least one temperature sensor is responsive to temperature characteristics in a vicinity of the plurality of flow sensors. The method further includes coupling a measurand separator to the plurality of flow sensors and the at least one temperature sensor, wherein the measurand separator is configured to generate an output signal based on at least one of the flow characteristics or temperature characteristics. The method additionally includes coupling a processor to the plurality of flows sensors, the at least one temperature sensor, and the measurand separator, wherein the processor is configured to determine a temperature compensated flow rate of the fluid flow in the flow conduit using the output signal. The processor is further configured to use the output signal from the measurand separator to select a processing method for determining the temperature compensated flow rate in the flow conduit.

In accordance with other various embodiments, a method for determining flow rate in a conduit is provided that includes acquiring measurements from a plurality of sensors in a flow conduit having disturbances imparted therein, wherein the measurements correspond to flow characteristic information and temperature characteristic information for a fluid flow within the flow conduit. The method also includes separating signal amplitude information from the measurements and determining a temperature compensated flow rate of the fluid flow in the flow conduit using the separated signal amplitude information, wherein a processing method for determining the temperature compensated flow rate selected based on the separated signal amplitude information.

### BRIEF DESCRIPTION OF THE DRAWINGS

FIG. 1 is schematic illustration of a flow sensor in accordance with various embodiments.

FIG. 2 is schematic illustration of a flow sensor with a bypass channel in accordance with an embodiment.

FIG. 3 is schematic illustration of a flow sensor with a bypass channel in accordance with another embodiment.

FIG. 4 is schematic illustration of a flow sensor in accordance with other various embodiments.

FIG. 5 is schematic illustration of a flow sensor in accordance with other various embodiments.

FIG. 6 is schematic illustration of a flow sensor in accordance with other various embodiments.

FIGS. 7 and 8 illustrate a printed circuit board that may be implemented in various embodiments.

FIG. 9 is a diagram of flow sensor assembly in accordance with an embodiment.

FIG. 10 is a diagram of flow sensor assembly in accordance with another embodiment.

FIG. 11 is a diagram of flow sensor assembly in accordance with another embodiment.

FIG. 12 is a diagram of flow sensor assembly in accordance with another embodiment.

FIG. 13 is a diagram of flow sensor assembly in accordance with another embodiment.

FIG. 14 is a diagram of flow sensor assembly in accordance with another embodiment.

FIG. 15 is a diagram illustrating an opening in a flow conduit for receiving a portion of the flow sensor assembly of FIG. 14.

FIG. 16 is a diagram of flow sensor assembly in accordance with another embodiment.

FIG. 17 is a block diagram illustrating a signal separator in accordance with an embodiment.

FIG. 18 is a block diagram illustrating a signal separator in accordance with another embodiment.

FIG. 19 is a flowchart of a method in accordance with an embodiment.

FIG. 20 is a flowchart of a method in accordance with another embodiment.

### DETAILED DESCRIPTION

The following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Although the various embodiments may be described herein within a particular operating environment, it should be appreciated that one or more embodiments are equally applicable for use with other configurations and systems. Thus, for example, the various embodiments may be used in connection with a ventilation and/or respiratory machine, as well as in different medical and non-medical applications.

Various embodiments provide systems and methods for flow sensing or detection using one or more flow sensors. For example, various embodiments use flow sensors to provide temperature sensing based amplitude correction for cross-correlated sensing of mass flow and/or volumetric flow. In some embodiments, a plurality of sensors are used to determine a temperature compensated flow rate of fluid flow in a fluid conduit. The flow rate determination may be used, for example, in ventilation and/or respiratory machines, such as continuous positive airway pressure (CPAP) machines and variable positive airway pressure (VPAP) machines. However, various embodiments may be used in other systems and applications, for example, natural (or other) gas metering applications, residential gas metering applications, etc. At least one technical effect of various embodiments is increased accuracy of flow sensing without drift and with a higher degree of robustness with respect to fluid density, mixture, temperature, and/or moisture variations. At least one technical effect of various embodiments is a more robust lower cost flow sensor.

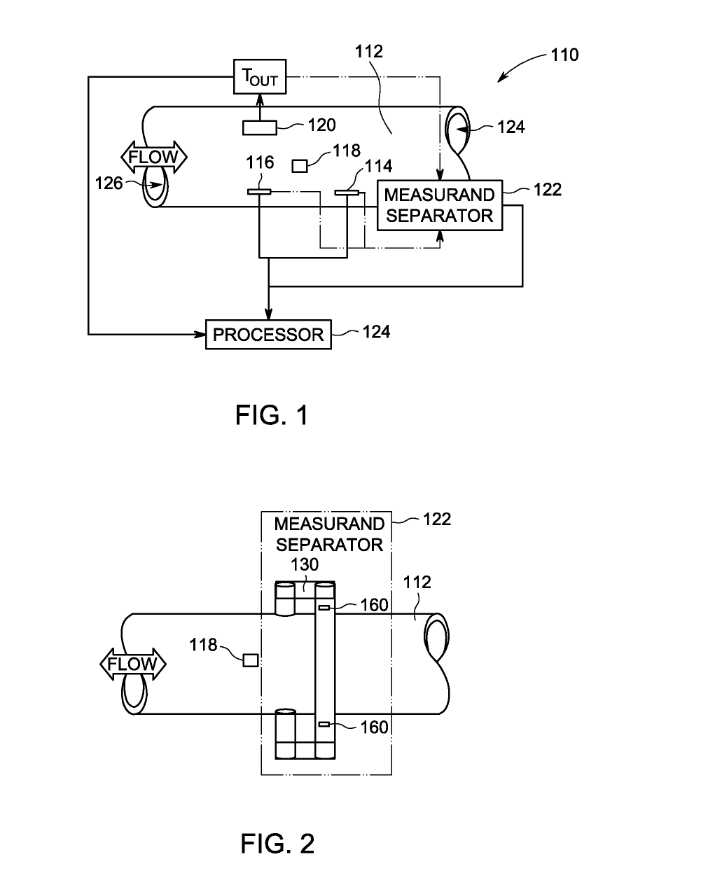

FIG. 1 illustrates schematically a flow sensor assembly 110 in accordance with an embodiment that may be used, for example, with a CPAP or VPAP machine to determine and control the flow of air to a user, such as to provide varying levels of positive airway pressure to a user when sleeping. However, as described herein, the flow sensor assembly 110 may be used in other application.

In general, the flow sensor assembly 110 includes a plurality of sensors, illustrated as the sensors 114 and 116 (which in various embodiments are flow sensors) that are disposed within a flow conduit 112 and are responsive to flow characteristics in the flow conduit. In some embodiments, the sensors 114 and 116 are configured (e.g., positioned within the flow conduit 112 and with respect to each other) to have a geometrical and functional relationship with the flow conduit 112 and a flow disturber 118 (or flow disrupter). For example, the sensors 114 and 116 are responsive to flow characteristics within the flow conduit 112 as described in more detail herein. At least one additional sensor 120 (e.g., a thermistor or thermopile device), which in various embodiments is a temperature sensor, is also disposed within the flow conduit 112 and configured (e.g., positioned within the flow conduit 112 and with respect to each other) to have a geometrical and functional relationship with the sensors 114 and 116. In various embodiments, the additional sensor 120 is responsive to temperature characteristics in vicinity or proximity to the sensors 114 and 116.

The sensors 114 and 116 in various embodiments are configured to generate signals characteristic of disturbances within the flow conduit 112. For example, the disturbances may include a disturbance of the fluid flow, pressure fluctuations in a flow conduit 112, acoustic waves (e.g., audible sound waves or ultrasonic acoustic waves), and acoustic energy, among others. Accordingly, a disruption in a fluid flow creates certain characteristics, which may include vortices or pressure/flow pulses that can be sensed and analyzed. In particular, fluid flow will have a certain direction, velocity, pressure, and temperature associated therewith. By placing a disruption in the fluid stream (such as using the flow disturber 118), the velocity is altered, as are the pressure and temperature. These changes, along with the temperature characteristics sensed by the sensor 120 can be detected and analyzed to determine a temperature compensated flow rate of fluid flow within the flow conduit 112. It should be noted that the temperature characteristics may be the temperature of the fluid in flow conduit upstream or downstream from the sensors 114 and 116, or of the sensors 114 and 116. For example, the sensor(s) 120 may be positioned within the flow conduit 112 adjacent each of the sensors 114, 116, such as on opposite upstream and downstream ends of the sensors 114, 116 as illustrated in FIG. 5.

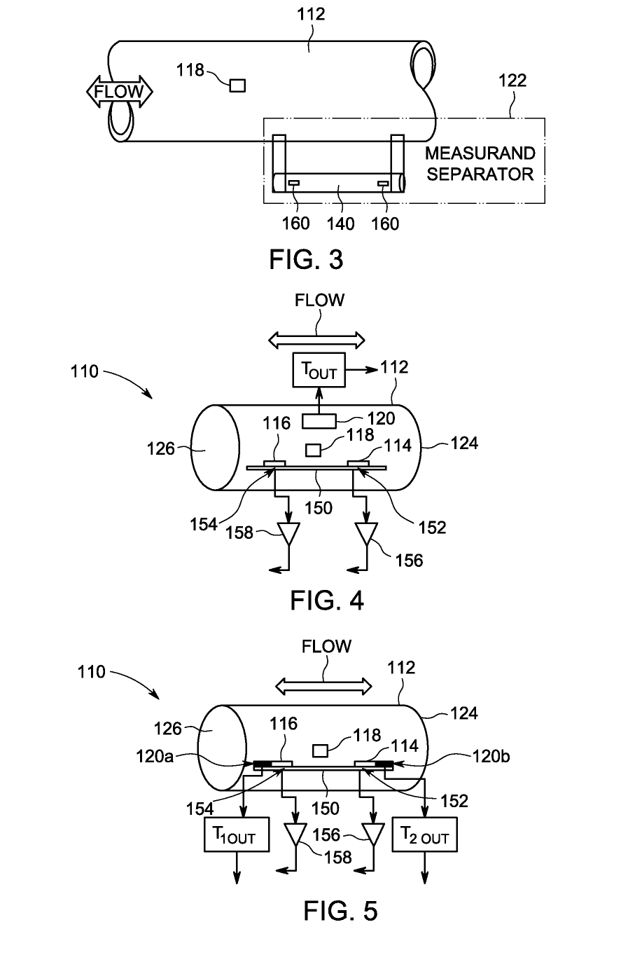

The sensors 114, 116, 120 are coupled to a signal separator (or measurement separator), illustrated as a measurand separator 122. For example, the sensors 114, 116, 120 may be operatively coupled (e.g., electrically coupled) to the measurand separator 122 such that the output signals from the sensors 114 and 116 responsive to the flow characteristics in the flow conduit 112, and the output signal(s) from the sensor 120 responsive to the temperature characteristics, are input to the measurand separator 122. As described in more detail herein, in various embodiments, the measurand separator 122 filters the output signals from the sensors 114, 116, 120, such as to separate the received alternating signal information measured by the sensors 114, 116, 120 from the signal amplitude to determine amplitude information for the flow within the flow conduit 112, which in various embodiments, facilitates determining a zero-crossing of the measured signal within a bypass channel 130 or 140 (shown in FIGS. 2 and 3 respectively). The zero-crossing point in some embodiments corresponds to a zero flow condition within the bypass channel 130 or 140, wherein a no flow condition or substantially no flow condition exists or is present.

The sensors 114, 116, 120 are also coupled to a processor 124. For example, the sensors 114, 116, 120 may be operatively coupled to the processor 124 such that the output signals from the sensors 114 and 116 responsive to the flow characteristics in the flow conduit 112, and the output signal(s) from the sensor 120 responsive to the temperature characteristics, are also input to the processor 124. Additionally, the measurand separator 122 is also connected to the processor 124. Thus, the processor 124 is operably coupled to the sensors 114, 116, 120 and the measurand separator 122 to receive measured and filtered data. The processor 124 is configured to determine a temperature compensated flow rate of the fluid flow in the flow conduit 112. In various embodiments as described in more detail herein, the processor 124 uses the output of the measurand separator 122 in selecting a processing method for determining the temperature compensated flow rate in the flow conduit 112 and a value for at least one additional temperature compensated measurand.

With respect particularly to the flow sensor assembly 110 that includes the pair of sensors 114, 116, which may be different types of sensing elements as described in more detail herein, each of the sensors 114, 116 is positioned within the flow conduit 112 that has an upstream opening 124 and a downstream opening 126. It should be understood that the terms “upstream” and “downstream” are relative terms that are related to the direction of flow, such as the flow of gas (e.g., air). Thus, in some embodiments, if the direction of flow 118 extends from element 126 to element 124, then element 126 is the upstream opening and element 124 is the downstream element. For ease of description, the upstream side of the flow sensor assembly 110 will be the side closest to the opening 124 and the downstream side of the assembly will be the side closest to the opening 126.

In various embodiments, the flow disturber 118 is positioned within the conduit 112, which in the illustrated embodiment is equidistant between the sensors 114, 116. However, the sensors 114, 116 may be positioned at different distances from the flow disturber 118. In one embodiment, the sensors 114, 116 are coupled or mounted to a printed circuit board (PCB) 150 at, respectively, first and second positions 152, 154 as described in more detail herein and shown in FIGS. 4 and 5. Other components, such as the sensor 120 may also be mounted to the PCB 150. The mounting of the components to the PCB 150 may use any process in the art and may include encapsulating the PCB 150 to make the PCB 150 fluid tight. Additionally, it should be noted that other support structures or substrates may be used and the various embodiments are not limited to the PCB 150. For example, in various embodiments, a ceramic substrate, a metalized plastic, and/or a rigid flexible (rigid flex) connector or circuit board, among others, may be used.

In operation, the flow disturber 118 is configured to form turbulence within the flow stream, such as, for example, waves or eddies, or vortices, where the flow is mostly a spinning motion about an axis (e.g., an imaginary axis), which may be straight or curved. Additionally, vortex shedding, for example, occurs as an unsteady oscillating flow that takes place when a fluid such as air flows past a blunt body such as the flow disturber 118 at certain velocities, depending to the size and shape of the body. The flow disturber 118 may be a passive (non-moving) or active device (moving, such as translating or rotating).

Thus, the flow disturber 118 causes the formation of turbulence within the flow conduit 112, such as vortices that travel downstream within the flow conduit 112. This turbulence is measured by the sensors 114, 116 that are responsive to the flow characteristics in the flow conduit 112. Additionally, with respect to the vortices created, for example, on different sides of the flow disturber 118 (such as above and below as viewed in FIG. 1), these vortices are out of phase with each other. In various embodiments, the vortices formed on different sides of the flow disturber 118 that are out of phase with each other are sensed and/or measured downstream as the vortices pass the sensors 114, 116. Thus, the measurements from the sensors 114, 116 may be used to determine a phase relationship between the sensed vortices created on the different sides of the flow disturber 118. Accordingly, each path on opposite sides of the flow disturber 118 creates separate vortices that are correlated to each other.

In various embodiments, the sensors 114, 116 are configured to acquire measurements and send signals to, respectively signal conditioners 156, 158 as illustrated in FIGS. 4 and 5, wherein the measurand separator 122 and processor 124 are not shown for ease of illustration. The signal conditioners 156, 158 condition the signals by, for example, filtering or amplifying the received signals, prior to sending the signals to anti-aliasing filters and the processor 124 for analysis. For example, the signals generated by the sensors 114, 116 are communicated to the processor 124 that is configured to determine a temperature compensated flow rate within the flow conduit 112, which may use detected the signals characteristic of phase based on a cross-correlation of the signals from the sensors 114, 116 and filtered signals from the measurand separator 122.

It should be noted that the locations of one or more of the first and second positions 152, 154, the shape of the flow disturber 118, the positioning of the flow disturber 118 relative to the sensors 114, 116 and within the conduit 112, and the size and positioning of the PCB 150 may be varied as desired or needed to generate particular disturbances within the conduit 112 and to allow measurement of the disturbances, such as the frequency and/or phase of the disturbances. For example, one or both of the sensors 114, 116 are positioned a defined distance from the flow disturber 118 to allow detection of the turbulent vortices or pressure/flow pulses caused by the flow disturber 118, in particular, within a distance where the disturbances have been formed, but not decayed to the point of being undetectable. These disturbances can be largely turbulent in nature. Thus, there are regions located at a distance from the flow disturber 118, at which the sensors 114, 116 are positioned and which have a geometrical relationship, wherein the error in the sensor reading is reduced or minimized. In one embodiment, the sensors 114, 116 are located equidistant from the flow disturber 118 as described herein. It should be noted that although only one flow disturber 118 is shown in FIG. 1, two or more flow disturbers 118 may be utilized within the conduit 112.

In operation, the characteristics, such as the vortices or disturbances in the form of pulses, of flow that can be determined are, for example, flow speed, flow direction, the pressure of the flow, the temperature of the flow, the change in velocity of the flow, the change in pressure of the flow, and the heat transfer of the flow. Thus, the sensors 114, 116 can be any type of sensor capable of sensing any one or more of these disturbances. For example, the sensors 114, 116 may be configured to determine pressure, temperature, change in pressure, change in temperature, or change in flow rate. In one embodiment, the sensors 114, 116 are pressure sensors. In another embodiment, the sensors 114, 116 are heaters (which may operate at a constant temperature mode such that a constant temperature is generated by the sensors 114, 116). In yet another embodiment, the sensors 114, 116 are microelectromechanical (MEMS) devices.

In some embodiments, such as wherein the flow sensor assembly 110 forms part of a CPAP or VPAP machine, a fan (and control motor), not shown, are in fluid connection with the flow conduit 112 to generate a flow of fluid, in this embodiment, air, through the flow conduit 112. A mask (not shown) is in fluid connection with the conduit 112, which may be configured as or form part of a flexible tube that is fluid connection with the fan. The fan is also communicatively coupled to the processor 124 to allow control of the fan. For example, the processor 124 uses signals received from the sensors 114, 116, 120 to control the operation of the fan, such as to vary the level of the speed of the fan or turn the fan on or off, which controls a flow of air to a the mask that may be worn by a person.

It should be noted that variations and modifications are contemplated. For example, different types of sensors 114, 116, 120 may be used. Additionally, different types of flow disturbers 118 may be used, such as passive actuators or active actuators that are configured to impart a disturbance to the flow within the flow conduit 112. For example, the flow disturber 118 may include two parts separated from each other (e.g., each being half-cylindrical in shape) by a flow separator, such as to form a channel or gap therebetween. The first and second parts in one embodiment are blunt flow disturbers. The first and second parts may be separate pieces or may be opposite sides of a single flow disturber that has a flow separator formed in a middle portion thereof.

The flow disturber 118 may be positioned orthogonal to the fluid flow direction through the flow conduit 112, such as coupled on opposing sides of the flow conduit 112. Additionally, the PCB 150 may be supported within the flow conduit 112 using different supporting structures as described herein to allow proper positioning within the flow conduit 112.

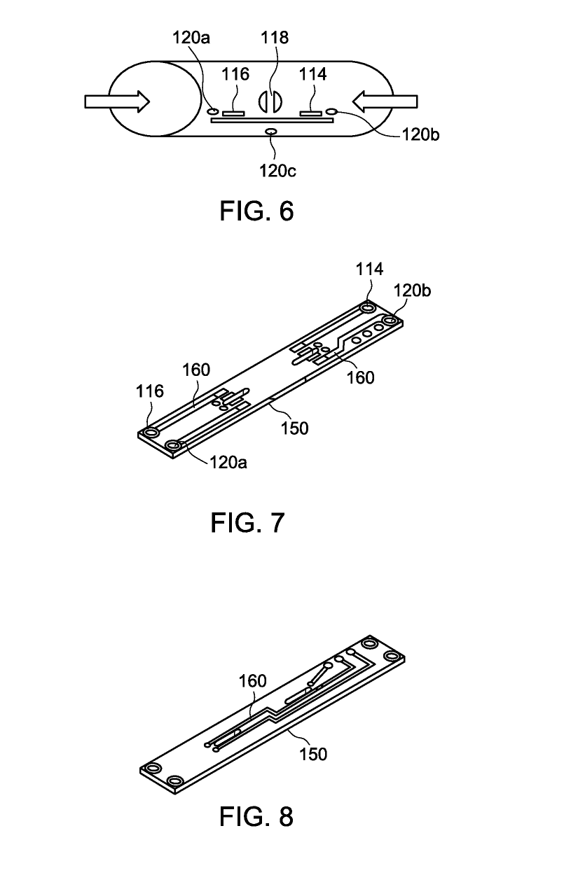

In operation, two or more sensors 120 (temperature sensors) may be provided as shown in FIG. 6, wherein the combination of the two sensors 120 are used in various embodiments to determine the direction of flow in the flow conduit 112. If, for example, the direction of flow is from left to right as viewed in FIG. 6, then the temperature sensor 120a will not detect heat from the sensor 116, which in this embodiment is a heater maintained at a constant temperature, but the temperature sensors 120a, 120b will detect heat from, respectively, the sensor 116 and the sensor 114, also being heaters in this embodiment. Thus, the difference in the amount of heat detected or measured by the two of sensors 120a, 120b can determine the direction of flow. Additional sensors 120 may be provided, for example, the sensor 120c.

In another embodiment, the direction of flow can be determined based on an amount of flow disruption. In particular, the flow disturber 118 will create, as a result of being in the fluid path, a higher flow downstream than is upstream. Thus, the upstream sensor will measure a lower flow rate than the downstream sensor.

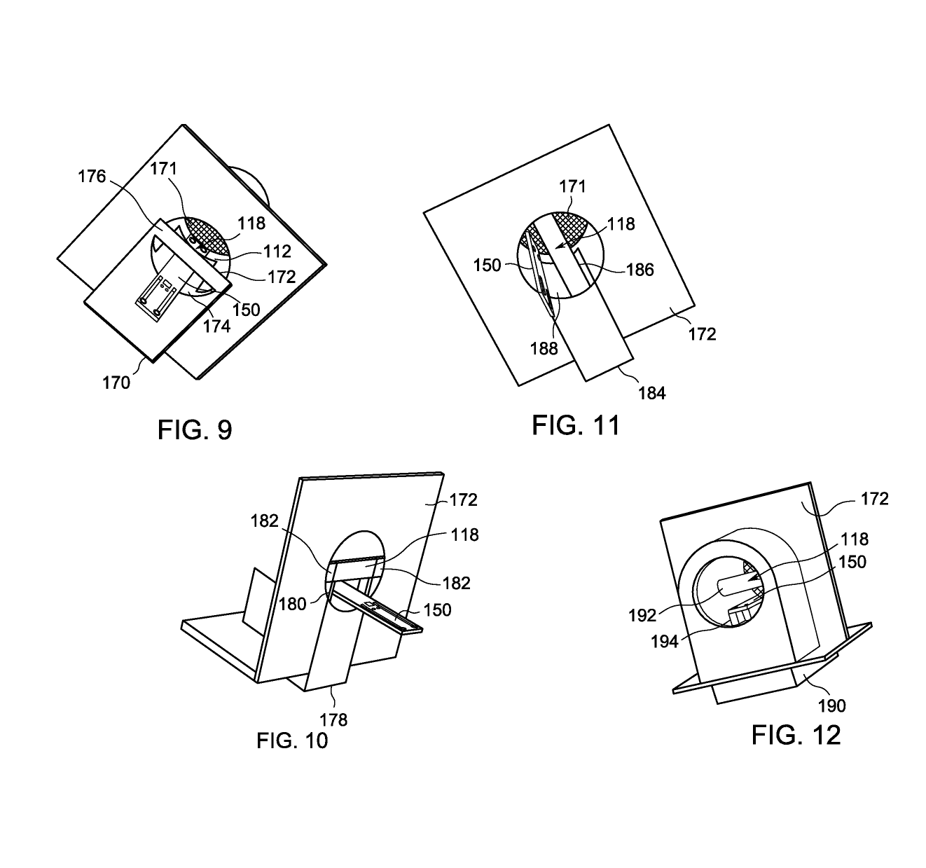

As examples of other variations, the PCB 150 may be coupled to a lower portion of the flow conduit 112 using anchors or other fasteners. It should be noted that signals from the PCB 150 and the sensors 114, 116, 120 may be communicated from the flow conduit 112 through electrical pins (not shown). It should be noted that other types of electrical connection arrangements may be used, for example, flexible electrical connections. Additionally, the flow conduit 112 may further include a straightener section that conditions the flow through the flow conduit 112. For example, the straightener section may include a screen 171 (shown in FIGS. 9 and 11) to assist in transitioning turbulent flow back into laminar flow. Various embodiments of assemblies are described in more detail herein.

The PCB 150 may be any type of PCB structure, for example, as shown in FIGS. 7 and 8 with the various components, such as the sensors 114, 116 and/or 120 mounted thereto and connected with signal traces 160, to allow output of the measured signals as described in more detail herein.

With respect to the bypass channel 130 or 140, as shown in FIGS. 2 and 3, the bypass channel 130 or 140 creates a flow path wherein a portion of the flow from the flow conduit 112 passes through the bypass channel 130 or 140. The bypass channel 130 or 140 may be, for example, a micro-channel having a size (e.g., diameter) smaller than the size of the flow conduit 112. The bypass channel 130 or 140 may be formed integrally with or separate from the flow conduit 112. In general, the bypass channel 130 or 140 is any structure (which may form a portion of the flow conduit 112) that allows flow out of the flow conduit 112 and back into the flow conduit 112. It should be noted that the configuration of the bypass channel 130 or 140 may be varied. For example, as shown in FIG. 2, the bypass channel 130 includes openings on opposite sides of the flow conduit 112, illustrated as above and below the flow conduit 112. It should be noted that in this embodiment, the bypass channel 130 is symmetrical from the upper and lower sides of the flow disturber 118 as viewed in FIG. 2. Thus, flow enters one end of the bypass channel 130 and exits the other end of the bypass channel 130, which may change direction as the flow rate changes within the flow conduit 112 and as described in more detail herein. Thus, the inlet and outlet for the bypass channel 130 is positioned at one axial position along the flow conduit 112 (but at different radial position). As illustrated in FIG. 3, for the bypass channel 140, the inlet and outlet are positioned at different axial locations along the flow conduit 112. For example, the bypass channel 140 may have openings on a same side (illustrated as a bottom side in FIG. 3) of the flow conduit 112. Thus, flow within the bypass channel 130 or 140 may be transverse (e.g., perpendicular) or parallel to flow within the flow conduit 112, respectively.

It should be noted that although the bypass channel 130 or 140 is shown as part of the measurand separator 122, the bypass channel 130 or 140 may be separate from the measurand separator 122.

Thus, the flow disturber 118 within flow the conduit 112 imparts a disturbance to the flow of fluid within the flow conduit 112 with the conduit 112 generally defining a main channel and the bypass channel 130 or 140 defining a secondary channel that has a smaller inner dimension (e.g., smaller inner diameter) than the flow conduit 112 and fluidly coupled thereto. For example, the bypass channel 130 or 140 may have a significantly smaller inner diameter than the flow conduit 112, such that fluid flow through the bypass channel 130 or 140 is forced to be laminar. The bypass channel 130 or 140 may be formed integrally with the flow conduit 112 or coupled thereto, for example, by cutting openings into the flow conduit 112 and securing the bypass channel 130 or 140 thereto covering the openings (which may be part of a separate supporting structure as described herein).

It should be noted that one or more sensors 160 may be positioned within the bypass channel 130 or 140, which may be similar to or embodied as the sensors 114, 116, and/or 118. It also should be noted that one of the sensors 160 may be positioned closer to one opening of the bypass channel 130 or 140 and the other sensor 160 positioned closer to the other opening of the bypass channel 130 or 140. The fluid flow changes direction (e.g., reverses direction) in the bypass channel 130 or 140, which may be detected and used to determine a thermal conductivity within the bypass channel 130 or 140, in particular, to determine when there is no fluid flow, namely at the point when fluid flow has reversed direction within the bypass channel 130 or 140. For example, if the sensor 116 is a heater, heat transfer into the flow (e.g., gas within in the flow), in particular thermal conductivity from the sensor 116 into the flow may be determined within the bypass channel 130 or 140 when there is no flow therein, such as when the flow is changing direction. Accordingly, the measured heat transfer corresponds to thermal conductivity and not thermal convection, which may exist if fluid flow is present. The thermal conductivity is related to the composition (e.g., gas mixture) within the flow. Thus, by determining the heat content within the flow, the composition of the flow may be determined, for example, the properties of the gas may be inferred.

In operation, the sensors 160 are configured to generate outputs signals similar to the sensors 114, 116, 118 as described herein and that may be conditioned as described herein. In particular, the flow disturber 118 imparts a disturbance to the flow within the flow conduit 112. In the case of a passive flow disturber, for example, the imparted disturbance is related to the geometric dimensions of the flow disturber. Additionally, the disturbance travels within the conduit, for example, a distance, in a given time period. In some embodiments, disturbances created by the flow disturber 118 travel within the flow conduit 112 at a speed between about 0.1 meters/second (m/s) to about 10 m/s. Thus, for example, the disturbance will travel the length between the openings of the bypass channel 130 or 140 in a time related to that speed. However, as described herein, the bypass channel 130 or 140 may be used to determine and/or generate a defined and/or unambiguous zero flow independent of the flow in the flow conduit 112. Thereafter, analysis or methods described herein may be used to determine other information relating to the disturbances and flow. It should be noted the frequency of the flow within the bypass channel 130 or 140 also may be used to determine information regarding the flow in the flow conduit 112 as described in more detail herein.

The sensors described herein may be positioned within the flow conduit 112 using different configurations or assemblies, such as shown in FIGS. 9-15. For example, different arrangements may be provided for positioning the PCB 150 with the sensors 114, 116, and/or 120 mounted thereto in the flow conduit 112. In various embodiments, a molded assembly (having support structure) may be provided that includes a positioning and support member for the PCB 150 for locating the PCB 150 within the flow conduit 112 and relative to the flow disturber 118. For example, as shown in the embodiment of FIG. 9, a planar support structure, illustrated as a plate 170 with the PCB 150 mounted thereto, may be positioned or aligned with the flow conduit 112 such that the PCB 150 is positioned along a side (e.g., along an inner wall) of the flow conduit 118. It should be noted that the plate 170 may be mounted to a housing 172 (a portion of which is shown in FIG. 9) defining the flow conduit 112 therein or may be formed as part of the housing 172. As can be seen, the plate 170 includes an arm 174 (illustrated as a curved extension conforming to the curvature of the inner surface of the flow conduit 112) that extends along a portion (axial length) of the flow conduit 112 to provide support and maintain position therein. In this embodiment, the PCB 150 is mounted to at least a portion of the arm 174, which may be within a slot (not shown) of the arm 174.

Additionally, the flow disturber 118 is formed as part of the plate 170. For example, the plate 170 includes a bar 176 (illustrated as a planar piece) at a top portion of the plate 170 (as viewed in FIG. 9) that extends across the diameter of the flow conduit 112 to form the flow disturber 118 within the flow conduit 112. The bar 176 may be sized and shaped as desired or needed as described in more detail herein. As can be seen, the bar 176 extends a distance beyond the inner diameter of the flow conduit 112.

Thus, the plate 170 includes a generally semi-cylindrical portion that extends along a portion of the radius of the flow conduit 112 and is sized and shaped such that the bar 176 extends across a middle portion of the flow conduit 112 with the PCB 150 mounted between the bar 176 and a base portion of the arm 174 (in a perpendicular relationship in the illustrated embodiment). However, the bar 176 may configured to extend across and/or along different portions of the flow conduit 112, as well as be positioned in a different orientation within respect to the plate 170. For example, as illustrated in FIG. 11, a plate 184 may be provided wherein a bar 186 (forming the flow disturber 118) extends from a base portion across the flow conduit 112 with the PCB 150 mounted along one edge to a portion of an arm 188 (e.g., mounted to a ridge or ledge extending along the flow conduit 112) instead of along one of the faces of the PCB 150 as shown in FIG. 9. Thus, the positioning arrangement of the components relative to the plate 184 is shifted 90 degrees compared to the plate 170.

In some embodiments, a plate 178 as shown in FIG. 10 may be provided having a bar 182 (forming the flow disturber 118) similar to the bar 176 of FIG. 9. However, in this embodiment, complementary portions are formed on the housing 172 within the flow conduit 112, shown as tabs 182 (e.g., protrusions) extending within the flow conduit 112 to align the bar 182 therein. For example, in this embodiment, the bar 182 is sized to align and fit within and between tabs 182 on opposing sides of the flow conduit 112, such as in an abutting alignment when the plate 178 is mounted to the housing 172. Thus, the tabs 182 facilitate mounting and aligning the various components within the flow conduit 112.

As another variation, shown in FIG. 12, a support structure 190 may be provided wherein the flow disturber 118 is formed from a rod 192 extending across the flow conduit 112. In this embodiment, the housing 172 may include an opening into which the support structure 190 is inserted. Thus, the support structure 190 is sized and shaped to align and fit within the opening and to be sealed therein (e.g., to form a fluid tight seal). The rod 192 is formed as part of the support structure 190 such that the rod 192 extends across a middle of the flow channel 112. Additionally, the PCB 150 is similarly positioned to the arrangement shown in FIG. 9. However, in this embodiment, support members 194 (e.g., vertically extending arms or posts as viewed in FIG. 12) extend within the flow conduit 112 radially from a wall of the flow conduit 112 to position the PCB 150 a distance from the inner wall of the flow conduit 112. As can be seen, flow within the flow conduit 112 then may be provided above and below the PCB 150.

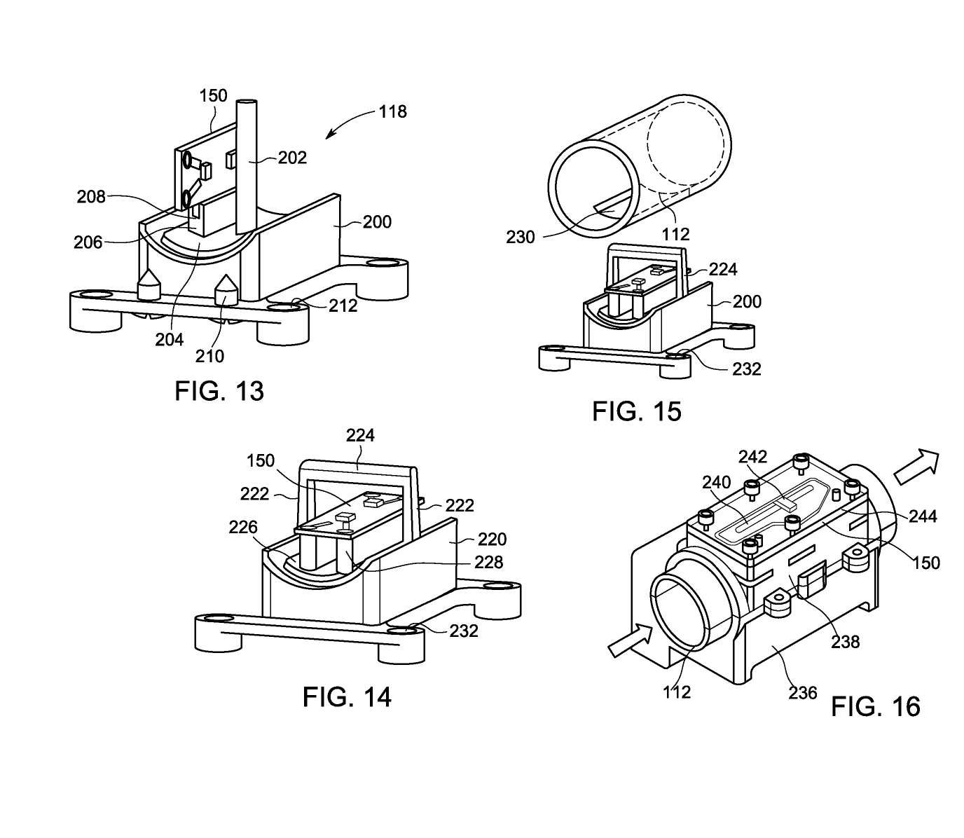

As another example, shown in FIG. 13, a support structure 200 may be provided that forms part of the flow conduit 112, such as inserted within an opening of the flow conduit 112 (as shown in a similar configuration of FIG. 15) to align the components therein. In this embodiment, the flow disturber 118 is formed from a rod 202 that extends generally perpendicular from a base 204 of the support structure 200. The rod 202 is sized to extend across the diameter or width of the flow conduit 112 when inserted therein. It should be noted that the rod 202 in various embodiment is integrally formed with the support structure 200 (e.g., as part of a molding process). However, the rod 202 may be separately formed and coupled thereto in other embodiments. Additionally, a PCB support member 206 is provided along the base 204 spaced apart from the rod 202 and having a slot 208 therein for receiving a portion (e.g., an edge) of the PCB 150. For example, the slot 208 may be sized and shaped to receive a portion of the edge of the PCB 150 therein (which may be epoxied thereto). It should be noted that various embodiments may include different types of coupling arrangement in addition to or instead of an epoxied coupling. For example, RTVs (room temperature vulcanizing silicones) and/or other adhesives, among other coupling arrangements and/or materials, may be used.

The PCB support member 206 maintains the PCB 150 spaced a distance from the base 204, and correspondingly spaced a distance from an inner wall of the flow conduit 112.

It should be noted that the support structure 200 may include alignment members 210 (e.g., pins) to align the support structure 200 with respect to the flow conduit 112. Additionally, mounting portions 212 (e.g., openings) may be provided to receive fasteners (e.g., bolts) therein to maintain alignment or coupling of the support structure to the flow conduit 112. It also should be noted that openings (not shown) may be formed within the base 204 that allow flow into channels (not shown) within a bottom portion of the support structure to define a bypass channel (e.g., the bypass channel 130 or 140 shown in FIGS. 2 and 3).

Variations and modifications are shown in FIGS. 14 and 15. In this embodiment, a support structure 220 is provided having arms 222 that extend therefrom (shown extending vertically upwards) with a rod 224 formed therebetween defining the flow disturber 118. Thus, the rod 224 is parallel to a base 226 of the support structure 220. Again, the support structure 220 and arms 222 are configured such that in various embodiments, the rod 224 is positioned in a middle portion of the flow conduit 112. In this embodiment, similar to FIG. 12, support members 228, illustrated as a plurality of rods (although any suitable support structure may be used) maintain the PCB 150 spaced apart from the base 226 and correspondingly spaced apart from an inner wall of the flow conduit 112. As can be seen in FIG. 15, an opening 230 within the flow conduit 118 is provided for receiving therein the support structure 200 such that the components are positioned therein. Openings 232 are also provided as part of the support structure 220 to maintain the support structure 220 in a fixed position, such as to receive fasteners (e.g., bolts) therethrough.

As illustrated in FIG. 16, a support structure 238 may be mounted to a portion 236 to form part of the flow conduit 112. As can be seen more clearly, one side of the PCB 150 may be outside the flow conduit 112 with a bypass channel 240 formed therein (which may be embodied as the bypass channel 130 or 140 of FIG. 2 or 3). For example, the bypass channel 240 may be formed within the PCB 150 or within a base portion of the support structure 238. Openings (not shown) are provided within the flow conduit 112 to allow flow into and out of the bypass channel 240 as described herein. Additionally, one or more sensors (one MEMS sensor 242 is shown) are provided as part of the PCB 150 as described in more detail herein. Additionally, a seal 244 (illustrated as an O-ring seal) is provided for a fluid tight seal between the flow conduit 112 and PCB 150.

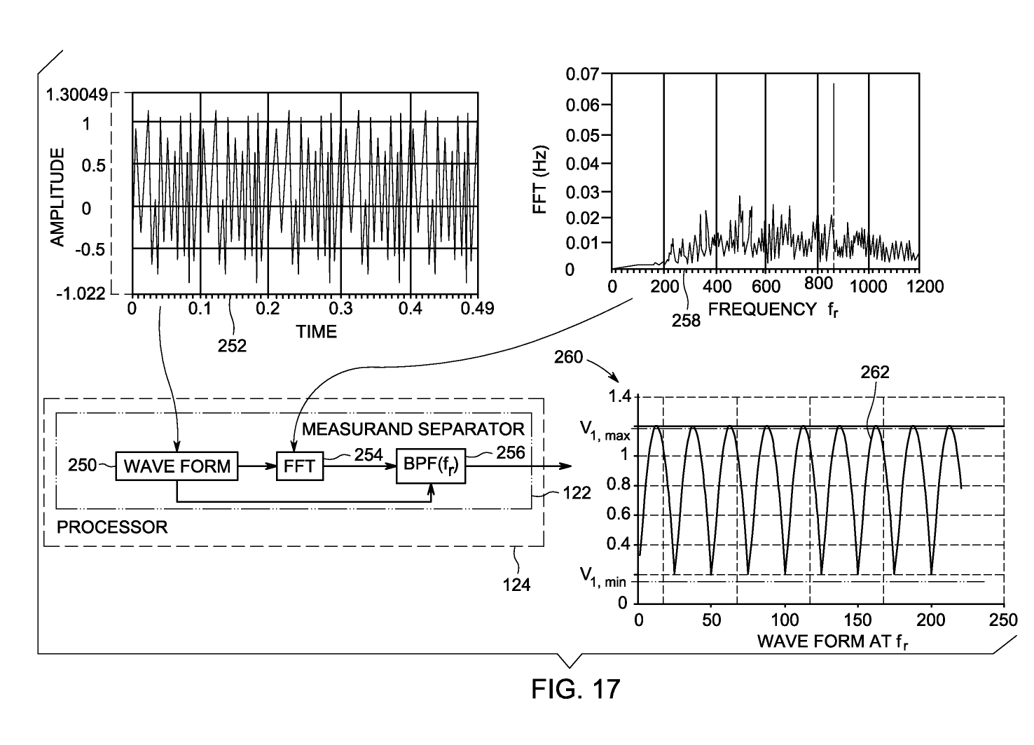

It should be noted that different configurations and arrangements may be provided to support the various components within the flow conduit 112 and the herein described structure are merely for illustration. Different structures may be used to position the various components within the flow conduit to allow temperature compensated flow rate determinations as described herein. Additionally, the processing portions may include different components to perform the functions described herein. For example, FIG. 17 illustrates one embodiment of the measurand separator 124, which may form part of the processor 124 (e.g., embodied as hardware and/or software). It should be noted that the modules forming part of the measurand separator 124 may be embodied in hardware and/or software.

The measurand separator 124 in this embodiment includes a waveform input module 250 that receives waveforms 252, such as measurements from the sensors 114, 116, 120 (shown in FIG. 1). The waveforms 252 are then input to a fast Fourier transform (FFT) module 254 that processes the raw waveforms 252. For example, the FFT module 254 may use an FFT algorithm in the art to compute the discrete Fourier transform (DFT) and the inverse of the waveforms 252. The Fourier transform converts time (or space) to frequency and vice versa. It should be noted that different Fourier transform methods may be used as desired or needed. The FFT module 254 is coupled to a band pass filter (BPF) 256 to filter the Fourier transformed signal, such as to a frequency range of interest, for example, fᵣ, as illustrated in the waveform 158. Thus, as can be seen in the waveform 260 output from the measurand separator 124, the sinusoidal curve 262 has identifiable maximum and minimum (peaks), such that the AC amplitude information has been separated from the signal amplitude. Accordingly, minimum flow or zero crossing points may be determined from the output of the measurand separator 124.

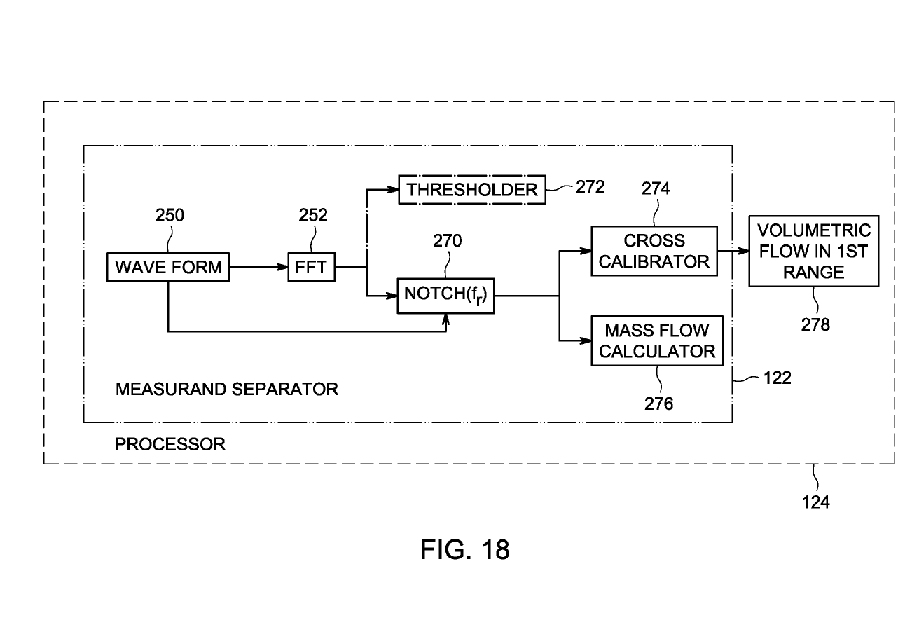

Additional or alternate processing may be added or provided to the measurand separator 124 as shown in FIG. 18. For example, a thresholder 272 and notch filter 270 (which may be embodied as the BPF 256) may be coupled to the output of the FFT 254. The thresholder 272 and notch filter 270 limit the output to a desired frequency range of interest, the output of which is then provided to a cross calibrator 274 and a mass flow calculator 276. The cross calibrator 274 in some embodiments is configured to determine interpolated values to be used when vortices are no longer forming as a result of flow in the flow conduit 112 being too slow. For example, different processing methods may be used based on a particular flow rate defining a flow regime. In particular, measurements from the different flow regimes may be used for calibrations. In some embodiments, different flow thresholds (as defined by the thresholder 272) may be selected based on when vortices are formed within the flow conduit 112 and calculations performed, such that an overlap region may be used to interpolate a linear relationship in the different regimes by using amplitude characteristics of the measured signals. This information may be used to calibrate the sensors below the threshold where vortices are not formed such that a mass flow may be calculated by the mass-flow calculator 276 using calibrated volumetric flow information, such as described in co-pending patent application Ser. No. 13/247,107 filed on Sep. 28, 2011, entitled “FLOW SENSOR WITH MEMS SENSING DEVICE AND METHOD FOR USING SAME”.

Thus, an output 278 corresponding volumetric flow in a first range may be provided by the measurand separator 122. Moreover, by determining heat transfer at a point in time when there is no flow (using the bypass channel 130 or 140), a determination may be made, for example, of the flow composition (e.g., gas mixture) within the flow conduit. Accordingly, properties of the composition of the flow within the flow conduit 112 may be determined using thermal conductivity for any flow range and gas species. Additionally, the volumetric flow may be converted to mass, such that both volumetric flow and mass flow may be determined.

In various embodiments as described herein, a temperature of the flow within the flow conduit 112 is accurately determined at a time when there is no flow within the bypass channels 130 or 140 (based on thermal conductivity that is not affected by thermal convection that occurs when there is flow). Using the temperature information, which may be measured by the sensors as described herein, direction correction of amplitude correction of the flow rate may be provided. It should be noted that the flow rate to be temperature sense based amplitude corrected (also referred to as temperature corrected) may be determined using different methods, such as described in co-ending application Ser. No. 13/969,041, entitled “SYSTEMS AND METHODS FOR HYBRID FLOW SENSING.”

In various embodiments, temperature correction may be determined using Vₒᵤₜ^{DC,χ} or

$${V}_{out}^{DC , i} = \frac{{( {V}_{out}^{DC , i} )}^{2}}{Tw - Tf} ,$$

where V is the correction value and T is the measured temperature. For example, using the determined temperature of the flow within the flow conduit 112, a temperature offset value may be determined. In some embodiments, by determining the temperature of the fluid flow (at a no flow time or condition), density variations resulting therefrom may be corrected. It should be noted that the temperature correction may be determined using different compensation and flow rate schemes. Thus, for example, a temperature correction value may be determined using a suitable method based on the particular application or flow requirements. Accordingly, in addition to the methods described herein, different temperature compensation or correction analysis may be performed once the temperature is determined as the no flow state or condition. For example, different temperature compensation calculation methods may be performed using the output information of various embodiments, such that the flow rate determination accounts, for example, for changes in temperature within the fluid flow.

Methods for determining a flow rate through a flow conduit are also provided. The methods, for example, may employ structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the methods may be able to be used as one or more algorithms to direct hardware to perform operations described herein.

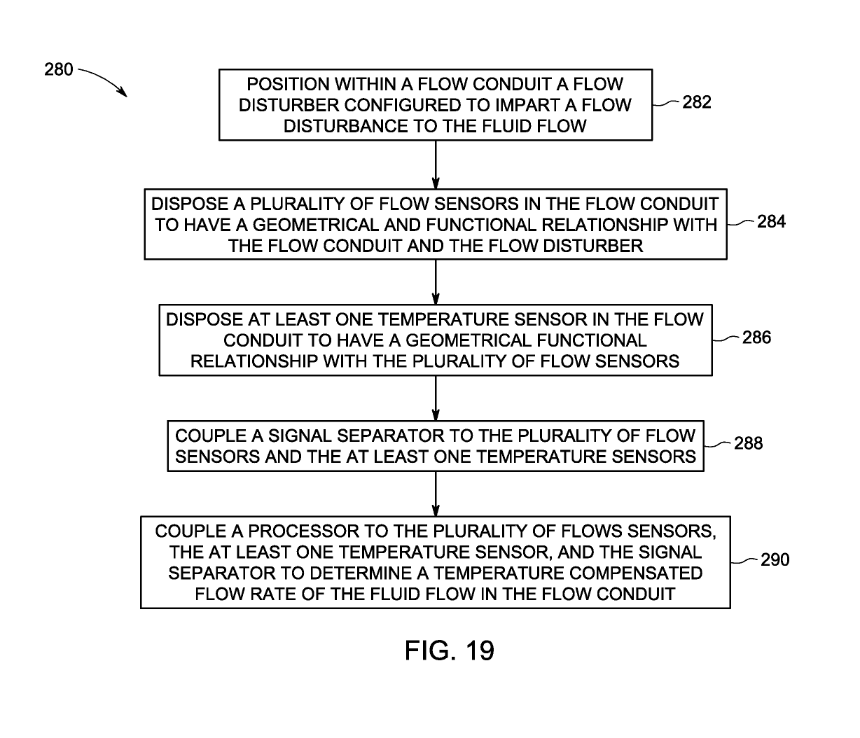

A method 280 as shown in FIG. 19 includes positioning within a flow conduit a flow disturber configured to impart a flow disturbance to the fluid flow at 282. For example, the flow disturber 118 may be positioned within the flow conduit 112 as described herein. The method 280 also includes at 284 disposing a plurality of flow sensors in the flow conduit to have a geometrical and functional relationship with the flow conduit and the flow disturber, wherein the plurality of sensors are responsive to flow characteristics in the flow conduit. The flow sensors may be, for example, the sensors 114 and 116. The method additionally includes at 286 disposing at least one temperature sensor in the flow conduit to have a geometrical and functional relationship with the plurality of flow sensors, wherein the temperature sensor is responsive to temperature characteristics in a vicinity (e.g., within a determined or defined distance) of the plurality of flow sensors. The temperature sensor may be, for example, the sensor 120. The method further includes at 288 coupling a signal separator to the plurality of flow sensors and the at least one temperature sensor, wherein the signal separator is configured to generate an output signal based on at least one of the flow characteristics or temperature characteristics. The signal separator may be, for example, the measurand separator 122.

The method 280 also includes at 290 coupling a processor to the plurality of flows sensors, the temperature sensor, and the signal separator. The processor may be the processor 124 that is configured to determine a temperature compensated flow rate of the fluid flow in the flow conduit and use the output signal from the signal separator to select a processing method for determining the temperature compensated flow rate in the flow conduit as described herein.

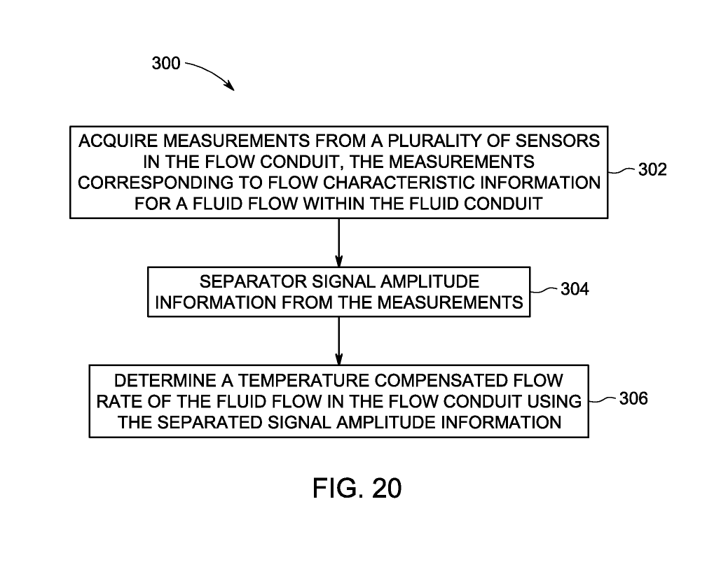

In another method 300 shown in FIG. 20, measurements from a plurality of sensors in a flow conduit are acquired at 302, such as the sensors 114, 116, and 120. The measurements may correspond to flow characteristic information and temperature characteristic information for a fluid flow within the flow conduit as described herein (that includes disturbances from a flow disturber). The method 300 also includes separating signal amplitude information from the measurements at 304, such as using the measurand separator 122 described herein. The method further includes at 306 determining a temperature compensated flow rate of the fluid flow in the flow conduit using the separated signal amplitude information, which may be performed by the processor 124. A processing method for determining the temperature compensated flow rate also may be selected based on the separated signal amplitude information.

Thus, various embodiments use flow sensors, such as in a flow sensor assembly for temperature sensing based amplitude correction for cross-calibrated mass flow-volumetric flow sensing.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and/or non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A flow sensor assembly comprising:
a flow conduit configured to allow fluid flow therethrough;
a flow disturber disposed in the flow conduit, the flow disturber configured to impart a flow disturbance to the fluid flow;
a plurality of flow sensors disposed in the flow conduit to have a geometrical and functional relationship with the flow conduit and the flow disturber, the plurality of sensors being responsive to flow characteristics in the flow conduit;
at least one temperature sensor disposed in the flow conduit to have a geometrical and functional relationship with the plurality of flow sensors, the at least one temperature sensor responsive to temperature characteristics in a vicinity of the plurality of flow sensors;
a measurand separator coupled to the plurality of flow sensors and the at least one temperature sensor, the measurand separator configured to generate an output signal based on at least one of the flow characteristics or temperature characteristics; and
a processor coupled to the plurality of flows sensors, the at least one temperature sensor, and the measurand separator, the processor configured to determine a temperature compensated flow rate of the fluid flow in the flow conduit using the output signal, the processor further configured to use the output signal from the measurand separator to select a processing method for determining the temperature compensated flow rate in the flow conduit.

2. The flow sensor assembly of claim 1, further comprising a bypass channel fluidly coupled to the flow conduit, the bypass channel allowing a portion of the fluid flow therethrough, the fluid flow through the bypass channel changing direction as a result of a change in a flow rate of the fluid flow in the flow conduit.

3. The flow sensor assembly of claim 2, wherein the processor is further configured to determine a time when substantially no fluid flow is present in the bypass channel.

4. The flow sensor assembly of claim 3, wherein the processor is further configured to determine, through thermal conductivity, a temperature of the fluid flow at the determined time of substantially no fluid flow in the bypass channel, the processor configured to use the temperature when determining the temperature compensated flow rate.

5. The flow sensor assembly of claim 1, wherein the processor is further configured to determine a value for at least one additional temperature compensated measurand using the output signal.

6. The flow sensor assembly of claim 1, wherein temperature characteristics comprise at least one of a temperature of fluid upstream from the plurality of flow sensors, a temperature of fluid downstream from the plurality of flow sensors, or a temperature of the plurality of flow sensors.

7. The flow sensor assembly of claim 1, further comprising a plurality of temperature sensors associated with the temperature characteristics of each of the plurality of flow sensors.

8. The flow sensor assembly of claim 1, wherein the plurality of flow sensors are heaters operating at a constant temperature mode.

9. The flow sensor assembly of claim 1, wherein the plurality of flow sensors comprises at least one of microelectromechanical (MEMS) sensors, pressure sensors or heaters.

10. The flow sensor assembly of claim 1, wherein the at least one temperature sensor comprises one of a thermistor or thermopile device.

11. The flow sensor assembly of claim 1, further comprising at least one printed circuit board (PCB) disposed in the flow conduit, the plurality of flow sensors mounted to the PCB, and a support structure extending into the flow conduit maintaining the PCB in a fixed position within the flow conduit.

12. The flow sensor assembly of claim 11, wherein the flow disturber is part of the support structure.

13. The flow sensor assembly of claim 12, wherein the flow disturber is one of a bar or rod formed as part of the support structure.

14. The flow sensor assembly of claim 12, wherein the support structure maintains the flow disturber in a middle portion of the flow conduit.

15. The flow sensor assembly of claim 11, wherein at least a part of the support structure forms a portion of the flow conduit.

16. The flow sensor assembly of claim 11, wherein the support structure includes one or more support members, the PCB coupled and supported by the support members such that the PCB is spaced apart from an inner wall of the flow conduit.

17. The flow sensor assembly of claim 11, further comprising a bypass channel fluidly coupled to the flow conduit, the bypass channel allowing a portion of the fluid flow therethrough, the bypass channel formed within at least one of the PCB or the support structure.

18. A method for determining flow rate in a conduit, the method comprising:
positioning within a flow conduit a flow disturber configured to impart a flow disturbance to the fluid flow;
disposing a plurality of flow sensors in the flow conduit to have a geometrical and functional relationship with the flow conduit and the flow disturber, the plurality of sensors being responsive to flow characteristics in the flow conduit;
disposing at least one temperature sensor in the flow conduit to have a geometrical and functional relationship with the plurality of flow sensors, the at least one temperature sensor responsive to temperature characteristics in a vicinity of the plurality of flow sensors;
coupling a measurand separator to the plurality of flow sensors and the at least one temperature sensor, the measurand separator configured to generate an output signal based on at least one of the flow characteristics or temperature characteristics; and
coupling a processor to the plurality of flows sensors, the at least one temperature sensor, and the measurand separator, the processor configured to determine a temperature compensated flow rate of the fluid flow in the flow conduit using the output signal, the processor further configured to use the output signal from the measurand separator to select a processing method for determining the temperature compensated flow rate in the flow conduit.

19. The method of claim 18, further comprising providing a bypass channel fluidly coupled to the flow conduit, the bypass channel allowing a portion of the fluid flow therethrough, the fluid flow through the bypass channel changing direction as a result of a change in a flow rate of the fluid flow in the flow conduit, and further configuring the processor to determine a time when substantially no fluid flow is present in the bypass channel and determine, through thermal conductivity, a temperature of the fluid flow at the determined time of substantially no fluid flow in the bypass channel, the processor using the temperature when determining the temperature compensated flow rate.

20. A method for determining flow rate in a conduit, the method comprising:
acquiring measurements from a plurality of sensors in a flow conduit having disturbances imparted therein, the measurements corresponding to flow characteristic information and temperature characteristic information for a fluid flow within the flow conduit;
separating signal amplitude information from the measurements; and
determining a temperature compensated flow rate of the fluid flow in the flow conduit using the separated signal amplitude information, a processing method for determining the temperature compensated flow rate selected based on the separated signal amplitude information.
